(19) United States
(12) Patent Application Publication
(10) Pub. No.: US 2026/0046371 A1
(43) Pub. Date: Feb. 12, 2026

(54) METHOD AND SYSTEM FOR REMOTE VIEWING OF REAL ESTATE

(71) Applicant: FOOTPRN TECHNOLOGIES LLC, Coweta, OK (US)

(72) Inventors: Vitaliy Alexandrovich Danysko, Olathe, KS (US); Matthew Sean Hibbets, Coweta, OK (US); Jeremy Brian Ward, Hudsonville, MI (US); Travis Taylor, Westminster, CO (US)

(73) Assignee: FOOTPRN TECHNOLOGIES LLC, Coweta, OK (US)

(21) Appl. No.: 18/800,644

(22) Filed: Aug. 12, 2024

(51) Int. Cl. H04N 7/14; G06Q 50/163

(52) U.S. Cl. CPC H04N 7/142; G06Q 50/163

(57) ABSTRACT

A system and method for remote viewing of property including storing one or more property profiles, each corresponding to a property and including at least a property identifier, a property floor plan, and a ground unit computing device identifier; receiving, from a user computing device, a user request to view a property, the user request including at least a property identifier; identifying a property profile including the property identifier included in the user request; establishing a connection to a ground unit computing device included in the identified property profile; generating a first data signal instructing the ground unit computing device to cause an imaging device to move to one or more locations; transmitting the first data signal to the ground unit computing device; and receiving, from the ground unit computing device, a live video feed from the imaging device of the one or more locations.

### FIELD

The present disclosure relates to remote viewing of property, specifically remote viewing of property using an imaging device to provide a live video feed of a property to a remote user.

### BACKGROUND

Virtual property tours have revolutionized the real estate industry by offering prospective buyers and tenants immersive, remote experiences of properties. Enabled by advanced digital technologies such as virtual reality (VR) and 360-degree photography, these tours allow users to navigate through homes and commercial spaces from the comfort of their own devices. They provide detailed views of interiors, exteriors, and even neighborhood surroundings, giving viewers a comprehensive sense of the property's layout, design, and ambiance. Virtual property tours not only save time and travel costs but also enhance decision-making by providing a more realistic and interactive preview compared to traditional photographs or videos. This innovative approach has become increasingly popular for real estate agents, developers, and property managers seeking to attract and engage a broader audience in the competitive market. However, current virtual property tours are limited by providing static videos and images of properties usually from a set vantage point.

Thus, there is a need for a technological solution that enables user to remote view a property in real-time and from a chosen vantage point.

### SUMMARY

A method for remote viewing of property, includes: storing, in a database, one or more property profiles, each of the one or more property profiles corresponding to a property, and each of the one or more property profiles including at least a property identifier, a property floor plan, and a ground unit computing device identifier; receiving, from a user computing device, a user request to view a property corresponding to one of the one or more property profiles, the user request including at least a property identifier; identifying a property profile of the one or more property profiles including the property identifier included in the user request; retrieving, from the database, a property floor plan included in the identified property profile; displaying the property floor plan on the user computing device via graphical user interface (GUI); establishing a connection to a ground unit computing device associated with the ground unit computing device identifier included in the identified property profile, wherein ground unit computing device is communicatively coupled to an imaging device; receiving a first user instruction, via the GUI, to view one or more locations within the property; generating a first data signal instructing the ground unit computing device to cause the imaging device move to the one or more locations within the property included in the first user instruction; transmitting the first data signal to the ground unit computing device; and receiving, from the ground unit computing device, a live video feed from the imaging device of the one or more locations.

A system for remote viewing of property, including: a user computing device; a ground unit computing device; an imaging device, and a processing server, the processing server configured to perform the method of: storing, in a database, one or more property profiles, each of the one or more property profiles corresponding to a property, and each of the one or more property profiles including at least a property identifier, a property floor plan, and a ground unit computing device identifier; receiving, from a user computing device, a user request to view a property corresponding to one of the one or more property profiles, the user request including at least a property identifier; identifying a property profile of the one or more property profiles including the property identifier included in the user request; retrieving, from the database, a property floor plan included in the identified property profile; displaying the property floor plan on the user computing device via graphical user interface (GUI); establishing a connection to a ground unit computing device associated with the ground unit computing device identifier included in the identified property profile, wherein ground unit computing device is communicatively coupled to an imaging device; receiving a first user instruction, via the GUI, to view one or more locations within the property; generating a first data signal instructing the ground unit computing device to cause the imaging device move to the one or more locations within the property included in the first user instruction; transmitting the first data signal to the ground unit computing device; and receiving, from the ground unit computing device, a live video feed from the imaging device of the one or more locations.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for remote viewing of property in accordance with exemplary embodiments;

FIG. 2 is a block diagram illustrating a processing server in the system of FIG. 1 for remote viewing of property in accordance with exemplary embodiments;

FIG. 3 is a block diagram of an example floor plan in the system of FIG. 1 for remote viewing of property in accordance with exemplary embodiments;

FIGS. 4A-4E are a flow diagrams illustrating a process for remote viewing of property in the system of FIG. 1 in accordance with exemplary embodiments;

FIG. 5 is a flow chart illustrating an exemplary method for remote viewing of property in accordance with exemplary embodiments; and FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### DETAILED DESCRIPTION

### System for Remote Viewing of Property

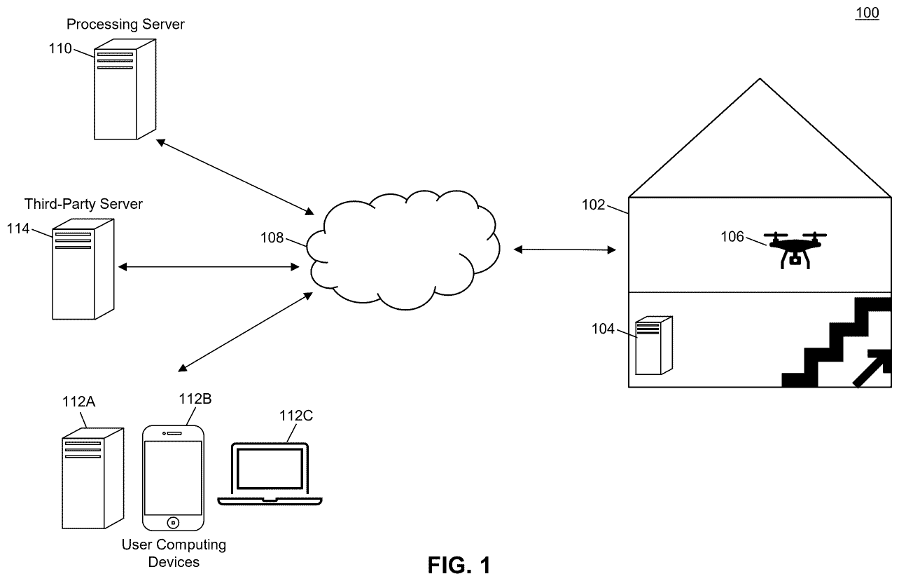

FIG. 1 illustrates a system 100 for the remote viewing of property. The system 100 can include a property 102, a ground unit computing device 104, an imaging device 106, a processing server 110, user computing devices 112A-C, and third-party server 114.

The property 102 can be a piece of real property such as a parcel of land and/or any buildings or improvements attached to the parcel of land. For example, the property 102 can be an apartment, an apartment building, a condo, a townhouse, a single-family dwelling, a multi-family dwelling, a commercial office space, a commercial building, a plot of land, etc. The property 102 can be a piece of personal property, such as, a car, a boat, a plane, heavy equipment, etc.

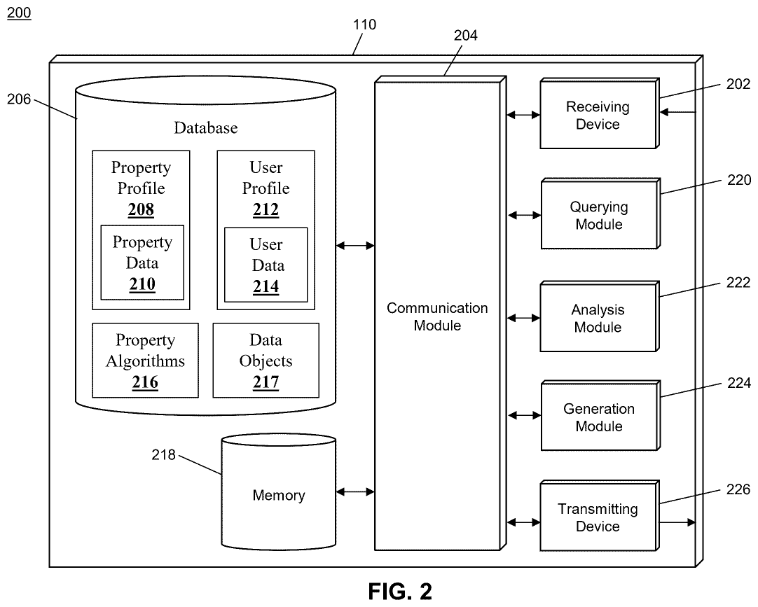

The ground unit computing device 104 can be a desktop computer, a laptop computer, a notebook computer, a tablet computer, a cellular phone, a smart phone, a smart watch, a smart television, a wearable computing device, an implantable computing device, or other device configured to perform the functions discussed herein. For example, the ground unit computing device 104 can be any computing device capable of receiving, storing, compiling, processing, and/or transmitting data to and/or from other computing devices including the imaging device 106, the processing server 110, the user computing devices 112A-C, and/or the third-party server 114. For example, the imaging device 106 captures imaging data (e.g., visual, thermal, etc.), as discussed in more detail below, and transmits the imaging data to the ground unit computing device 104 for storage and/or transmission to the processing server 110 and/or the user computing devices 112A-C via the network 108. Further, the ground unit computing device 104 may process the imaging data or any other data signals received from the imaging device 106 and/or data signals received from the other computing devices of the system 100, e.g., the processing server 110, and/or the user computing devices 112A-C. The processing of the image data and/or data signals is discussed in more detail below with reference to FIG. 2 and the processing server 110. In the system 100, the ground unit computing device 104 is a ground station computing device communicatively coupled to the imaging device 106 located in or otherwise associated with the property 102. The ground unit computing device 104 and the imaging device 106 can be communicatively coupled by any suitable wired and/or wireless communication method, such as radio frequency, local area networks, wireless area networks, cellular communication networks, Bluetooth, the Internet, etc. For example, the ground unit computing device 104 and the imaging device 106 can be communicatively coupled via a local area network associated with the property 102.

The imaging device 106 can be any controllable device equipped with imaging technology. For example, the imaging device 106 can be a drone (e.g., an unmanned aerial vehicle (UAV), an unmanned aircraft system (UAS), a small unmanned aerial system (sUAS), a remotely piloted aircraft system (RPAS), a micro air vehicle (MAV), etc.), a robot, or any other controllable device capable of performing the functions discussed herein including receiving, storing, compiling, processing, and/or transmitting data to and/or from other computing devices such as the ground unit computing device 104, the processing server 110, the user computing devices 112A-C, and/or the third-party server 114. The imaging device 106 includes at least one imaging technology such as a camera capable of capturing image data in 360 degrees or any other suitable camera capable of capturing image data. For example, the imaging device 106 captures image data, e.g., video, of the property 102 and transmits that image data to the ground unit computing device, the processing server 110, the user computing devices 112A-C, and/or the third-party server 114. The imaging device 106 can also include one or more sensors such as a lidar, an infrared sensor, an ultrasonic sensor, wheel encoders, a stereo camera, an embedded computer, an inertial measurement unit, an infrared laser dot projector, etc. The imaging technology and/or the one or more sensors enable to the imaging device 106 to navigate the property 102 either autonomously and or under control of one or more other computing device such as the ground unit computing device 104, the processing server 110, the user computing devices 112A-C, and/or the third-party server 114. For example, the imaging technology and/or one or more sensors of the imaging device 106 enable the system 100 to perform Simultaneous Localization and Mapping (SLAM) to build a two-dimensional or three-dimensional map of the property 102, e.g. a floor plan, as discussed in more detail with reference to FIGS. 2-5. Further, the imaging technology and/or one or more sensors of the imaging device 106 can enable a user, e.g., via a user interface on the user computing device 112A, to virtually tour the property 102. The imaging technology and/or one or more sensors of the imaging device 106 also enable the system 100 to measure distances within the property 102 such as a wall height, a wall width, a floor length, a floor width, a ceiling height, a doorway height, a doorway width, a window height, a window width, a window distance from a floor, an object width, an object depth, and an object length, etc. For example, the imaging device 106 can receive a data signal from another computing device such as the ground unit computing device 104, the processing server 110, the user computing devices 112A, and/or the third-party server 114 to measure a wall length in a particular area of the property 102 and the imaging device will measure the distance using the imaging technology and/or one or more sensors. The imaging technology and/or one or more sensors of the imaging device 106 also enable the system 100 to generate an augmented virtual reality video of the property 102. For example, as discussed in more detail below with reference to FIGS. 2-5, a user, e.g., via a user interface on the user computing device 112A, can insert a virtual object, e.g., a piece of furniture, into the augmented virtual reality video of the property 102.

The network 108 can be any suitable communication network that enables communication between the devices of the system 100 such as the ground unit computing device 104, the imaging device 106, the processing server 110, the user computing devices 112A-C, and/or the third-party server 114. For example, the network 108 may be, but is not limited to, a wired connection, a wireless network (e.g., WiFi), a mobile communication network, a satellite network, the Internet, fiber optic, coaxial cable, infrared, radio frequency (RF), or any combination thereof. Other suitable network types and configurations for the network 108 will be apparent to persons having skill in the relevant art. In embodiments, the network 108 can be a peer-to-peer network enabling peer-to-peer communications between the devices of the system 100. For example, the network 108 can use Web Real-Time Communication (Web RTC) to provide peer-to-peer communications between the devices of the system 100.

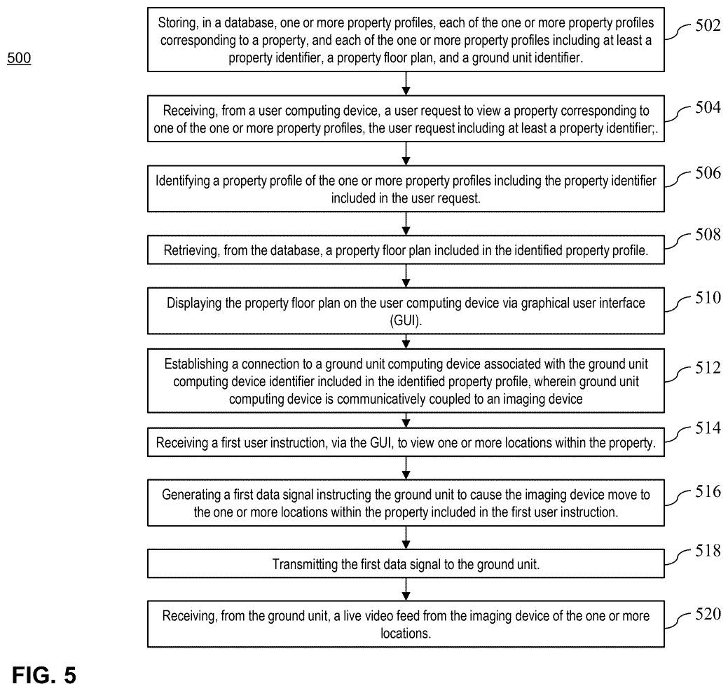

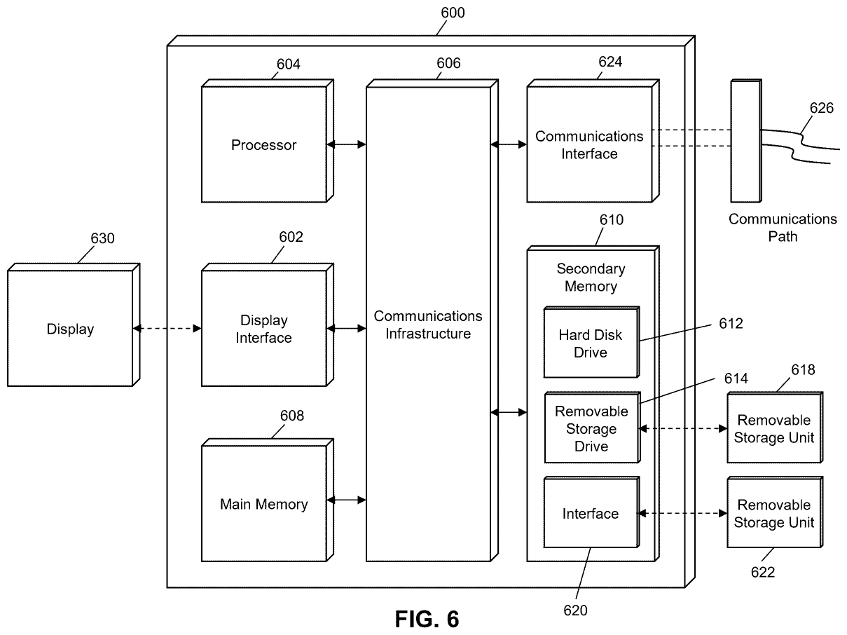

The processing server 110, discussed in more detail below, can be a computing system, such as illustrated in FIG. 2 or 5, discussed in more detail below, of an entity that enables the imaging and remote viewing of the property 102. For example, the processing server 110 can be a desktop computer, laptop computer, notebook computer, tablet computer, cellular phone, smart phone, smart watch, smart television, wearable computing device, implantable computing device, or other device configured to perform the functions discussed herein such as receiving, storing, compiling, processing, and/or transmitting data to and/or from other computing devices including the ground unit computing device 104, the imaging device 106, the user computing devices 112A-C, and/or the third-party server 114. In some embodiments, the processing server 110 may include and/or be comprised of a plurality of engines and/or modules specially configured to perform one or more functions of the processing server 110, such as the querying module 220, the analysis module 222, and the generation module 224, etc. As used herein, the term “module” may be software or hardware particularly programmed to receive an input, perform one or more processes using the input, and provides an output. The input, output, and processes performed by various modules will be apparent to one skilled in the art based upon the present disclosure. In embodiments, the processing server 110 may function as a proxy server for the system 100 by acting as an intermediary between the ground unit computing device 104, the imaging device 106, the user computing devices 112A-C, and/or the third-party server 114.

While the ground unit computing device 104, the imaging device 106, and the processing server 110 are illustrated separately, it can be appreciated that all three devices can be managed by a single entity. Further, it can be appreciated that the functions of each of the ground unit computing device 104, the imaging device 106, and the processing server 110 can be performed by a single computing device or any number of suitable computing devices. For example, the ground unit computing device 104 and the imaging device 106 can be a single computing device in communication with the other devices, e.g., the processing server 110 and the user computing device 112A-C, of the system 100. In another example, the ground unit computing device 104 and the processing server 110 can be a single computing device in communication with the other devices, e.g., the imaging device 106 and the user computing device 112A-C, of the system 100. In yet another example, the ground unit computing device 104, the imaging device 106, and the processing server 110 can be a single computing device in communication with the user computing device 112A-C in the system 100.

The system 100 can include one or more user computing devices 112A-C. Each computing device 112A-C can be a desktop computer, laptop computer, notebook computer, tablet computer, cellular phone, smart phone, smart watch, smart television, wearable computing device, implantable computing device, or any other suitable device configured to perform the functions discussed herein such as receiving, storing, compiling, processing, and/or transmitting data to and/or from other computing devices including the ground unit computing device 104, the imaging device 106, the processing server 110, and/or the third-party server 114. The user computing devices 112A-C can include a user interface configured to enable a user of the computing devices 112A-C to interact with the system 100. For example, the user interface includes components used to receive input from a user on the user computing devices 112A-C and transmit the input one or more other devices in the system 100 such as the ground unit computing device 104, the imaging device 106, the processing server 110, and/or the third-party server 114, or conversely to receive information from the one or more other devices in the system 100 and display the information to the user on the user computing devices 112A-C. In an embodiment, the user interface uses a combination of technologies and devices, such as device drivers, to provide a platform to enable users of the user computing devices 112A-C to interact with the system 100. In the example embodiment, the user interface receives input, such as but not limited to, textual, visual, or audio input received from a physical input device, such as but not limited to, a keypad and/or a microphone. As an example, a user on user computing device 112A can, via a user interface, select the property 102 for remote viewing and enter one or more user inputs related to viewing the property 102 such as, viewing one or more specific locations in the property 102, controlling the imaging device 106, measuring one or more distances in the property 102, inserting augmented reality object within the property 102, set a height of the imaging device 106, etc. Further, the user interface can be configured to display video feeds to a user on the user computing device 112A-C such as a live video feed of the property 102 from the imaging device 106. In embodiments, the user interface can be an application programming interface (API). For example, the API may enable users of the user devices 112A-C to communicate directly with the devices of the system 100, e.g., the ground unit computing device 104, the imaging device 106, the processing server 110, and/or the third-party server 114.

While three user devices 112A-C is illustrated, it can be appreciated that any number of user devices 112 may be associated with the system 100 including less than three or more than three.

The system 100 can include third-party server 114. Each third-party server 114 can be a desktop computer, laptop computer, notebook computer, tablet computer, cellular phone, smart phone, smart watch, smart television, wearable computing device, implantable computing device, or any other suitable device configured to perform the functions discussed herein such as receiving, storing, compiling, processing, and/or transmitting data to and/or from other computing devices including the ground unit computing device 104, the imaging device 106, the processing server 110, and/or the user computing devices 112. In embodiments, the third-party server 114 is a server of a third-party website, mobile application, or any other suitable electronic platform that provides goods and/or services to real estate such as, but not limited to, a retailer, a wholesaler, a manufacturer, a distributor, and/or a service provider, etc. For example, the third-party server 114 can be a furniture retailer. A user, e.g., via a user interface on the user computing devices 112A-C, may access a web page hosted by the third-party server 114 and utilize images of goods, e.g., furniture, home decor, etc., to virtually stage the property 102, as discussed in more detail below.

The methods and systems discussed herein provide for remote viewing of property. More particularly, the methods and systems discussed herein deploy a remote imaging device to a property that enables mapping of the property, generating a floor plan, enables remote users to receive live video tours of the property, and enables remote users to virtually tour and stage the property. Users of the methods and systems discussed herein can interact with and control the remote imaging device in real time to view the property as if they were actually on the property. Further, the methods and systems discussed herein enable the tracking and monitoring of user interactions with the property such as tracking the progress of users through the property, e.g., how much of the property was viewed, if users inserted virtual objects within the property, etc. The result is a significant improvement remote property tours for users who cannot physically view a property by providing them with a live on-demand video-based interaction with the property. Further, the methods and systems discussed herein provide a significant improvement for property owners and/or their agents in selling property by automating routine tasks and providing detailed metrics about property showings.

### Processing Server

FIG. 2 illustrates an embodiment of the processing server 110. It will be apparent to persons having skill in the relevant art that the embodiment of the computing system 200 illustrated in FIG. 2 is provided as illustration only and cannot be exhaustive to all possible configurations of the computing system 200 suitable for performing the functions as discussed herein. For example, the computer system 600 illustrated in FIG. 6 and discussed in more detail below can be a suitable configuration of the processing server 110. Further, as discussed above, the processing server 110 can be configured to perform the functions of one or more other computing devices in the system 100, e.g., the ground unit computing device 104 and/or the imaging device 106; thus, the computing device 104 and/or the imaging device 106 can also include the components of the computing system 200 illustrated in FIG. 2 and discussed in more detail below.

The processing server 110 can include a receiving device 202. The receiving device 202 can be configured to receive data over one or more networks via one or more network protocols, e.g., the network 108. In some instances, the receiving device 202 can be configured to receive data from the ground unit computing device 104, the imaging device 106, the user devices 112A-C, and other systems and entities via one or more communication methods, such as radio frequency, local area networks, wireless area networks, cellular communication networks, Bluetooth, the Internet, etc. In some embodiments, the receiving device 202 can be comprised of multiple devices, such as different receiving devices for receiving data over different networks, such as a first receiving device for receiving data over a local area network and a second receiving device for receiving data via the Internet. The receiving device 202 can receive electronically transmitted data signals, where data can be superimposed or otherwise encoded on the data signal and decoded, parsed, read, or otherwise obtained via receipt of the data signal by the receiving device 202. In some instances, the receiving device 202 can include a parsing module for parsing the received data signal to obtain the data superimposed thereon. For example, the receiving device 202 can include a parser program configured to receive and transform the received data signal into usable input for the functions performed by the processing device to carry out the methods and systems described herein.

The receiving device 202 can be configured to receive data signals electronically transmitted by the user devices 112A-C, which can be superimposed or otherwise encoded with property viewing requests, property tour inputs, property measurement requests, virtual object requests, virtual object specification inputs, imaging device requests, etc. The receiving device 202 can also be configured to receive data signals electronically transmitted by the ground unit computing device 104 and/or the imaging device 106 that can be superimposed or otherwise encoded with images of property, video of property, live video of property, augmented reality video of property, virtual reality video of property, property metrics, property measurements, property floor plans, sensor data, etc.

The processing server 110 can also include a communication module 204. The communication module 204 can be configured to transmit data between modules, engines, databases, memories, and other components of the processing server 110 for use in performing the functions discussed herein. The communication module 204 can be comprised of one or more communication types and utilize various communication methods for communications within a computing device. For example, the communication module 204 can be comprised of a bus, contact pin connectors, wires, etc. In some embodiments, the communication module 204 can also be configured to communicate between internal components of the processing server 110 and external components of the processing server 110, such as externally connected databases, display devices, input devices, etc. The processing server 110 can also include a processing device. The processing device can be configured to perform the functions of the processing server 110 discussed herein as will be apparent to persons having skill in the relevant art. In some embodiments, the processing device can include and/or be comprised of a plurality of engines and/or modules specially configured to perform one or more functions of the processing device, such as the querying module 220, the analysis module 222, and the generation module 224, etc. As used herein, the term “module” can be software or hardware particularly programmed to receive an input, perform one or more processes using the input, and provides an output. The input, output, and processes performed by various modules will be apparent to one skilled in the art based upon the present disclosure.

The processing server 110 can also include database 206. The database 206 can be a relational database that utilizes structured query language for the storage, identification, modifying, updating, accessing, etc. of structured data sets stored therein. The database 206 can be configured to store the one or more property profiles 208, each of which include property data 210. For example, the property profile 208 can correspond to the property 102 and can include property data 210 such as, a floor plan of the property 102, waypoints of the property 102, a ground computing device 104 identifier, an imaging device 106 identifier, a property identifier, property details (e.g., a property address, number of bedrooms, number of bathrooms, property square footage, sale price, sales history, property neighborhood data, property tax history, property description, etc.), property viewing metrics, property video data, property image data, property reports, etc. The database 206 can be configured to store one or more user profiles 212, each of which include user data 214. For example, each of the users of the user computing devices 112A-C in the system 100, can have a user profile 212 that includes user data 214 such as a user identifier (e.g., a user name), user credentials, a user device 112 identifier, user property history (e.g., how many properties viewed in the system 100, which properties were viewed, percentage of each property viewed, user interactions with each property viewed), user location data, etc. The database 206 can also be configured to store one or more property algorithms 216 for use in performing the functions discussed herein. The one or more property algorithms 216 can include deep learning algorithms, artificial neural networks, convolutional neural networks (CNN), recurrent neural networks (RNN), generative adversarial neural networks (GANN), feedforward neural networks (FNN), a large language model (LLM), a Simultaneous Localization and Mapping (SLAM) algorithm or any other suitable machine learning algorithms and/or neural networks capable of performing the functions discussed herein. For example, the one or more property algorithms 216 may include a large language model (LLM) capable of receiving user audio input from the user computing devices 112A-C and translating the user audio input into instructions to one or more of the devices of the system 100, e.g., the ground unit computing device 104, the imaging device 106, and/or the processing server 110. Further, in embodiments, a large language model may be used by the processing server 110 to generate a description of the property 102 based on the property data 210. The one or more property algorithms 216 may also include a Simultaneous Localization and Mapping (SLAM) algorithm capable of receiving image data and/or sensor data of the property 102 from the ground unit computing device 104 and/or the imaging device 106 and generating a floor plan of the property 102. The one or more property algorithms 216 may be trained using the data captured by the system 100, e.g., property image data captured by the imaging device 106, resulting in a machine learning algorithm and/or neural network capable of generating a floorplan of the property 102. Alternatively, a machine learning algorithm and/or a neural network may be trained using data from one or more datasets of known properties. The system 100 and/or the processing server 110 may utilize any suitable type of machine learning algorithm such as, but not limited to, a supervised machine learning algorithm, a semi-supervised machine learning algorithm, an unsupervised machine learning algorithm, and/or a reinforcement machine learning algorithm. The database 206 can also be configured to store one or more data objects 217. The data objects 217 may be data objects configured to be inserted by a user, e.g., of the user computing device 112A-C, into an augmented virtual reality video feed of the property 102. For example, the data objects 217 may be pieces of furniture, appliances, people, animals, home decor, windows, doors, etc. The data objects 217 can have set dimensions and/or the dimensions of the data objects 217 can be set by a user, e.g., via the user computing devices 112A-C. For example, a user may wish to visualize how their own furniture would look inside the property 102; so, the user can select and define dimensions for one or more of the data objects 217 to correspond to their own furniture and insert the data objects into specific locations within the property 102. In embodiments, the data objects 217 may be retrieved from the third-party server 114. For example, the processing server 110 may store product images retrieved from the third-party server 114 in the database 210 as the data objects 217. The database 206 may also store links, e.g., hyperlinks to a web page hosted by the third-party server 114, to purchase the products corresponding to the data objects 217. Further, the processing server 110 may store one or more codes associated with data objects 217 such as, a discount purchase code, a sponsor code associated with the processing server 110, etc.

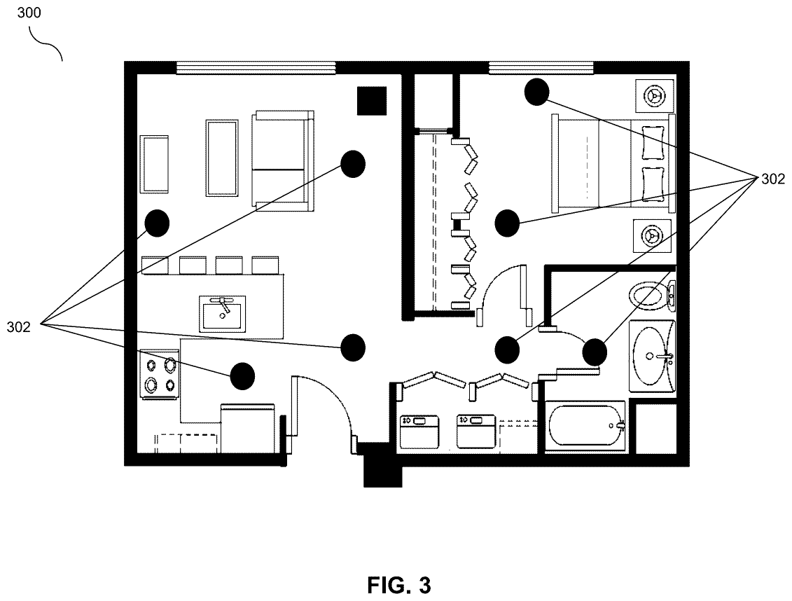

Referring to FIG. 3, floor plan 300 of the property 102 generated by the system 100, e.g., by the ground unit computing device 104, the imaging device 106, and/or the processing server 110, is illustrated. The floor plan 300 may be generated by the system 100, e.g., by the ground unit computing device 104, the imaging device 106, and/or the processing server 110, based on one or more images and/or videos captured by the imaging device 106. The processing server 110 can receive image data, e.g., images, videos, and/or scans, etc., of the property 102 from the imaging device 106, via the ground unit computing device 104, and insert the image data of the property 102 into an algorithm, e.g., one or more of the property algorithms 216. For example, one of the property algorithms may be a trained machine learning model that generates floor plans based on image data. In order to generate a floor plan, the trained machine learning model, e.g., an image classifier model, may be identify and label room types within the generated floor plan. For example, a video feed from the imaging device 106 can be broken down into smaller chunks by the machine learning model to identify and label room types, such as a kitchen, a living room, a dining room, a bedroom, an office, a bathroom, etc. Once the machine learning model has identified the various rooms of the property 102, the learned labels can then be mapped, e.g., by the same machine learning model or a different property algorithm 216, to a two-dimensional or three-dimensional floor plan. Further, the same machine learning model or a different property algorithm 216, can identify one or more waypoints 302 in the generated floor plan. The waypoints 302 are positions within the property 102 from which one or more of the identified rooms is best viewed, e.g., via the imaging device 106. The number of waypoints 302 may be determined by the machine learning model or the number of waypoints 302 may be defined as an input parameter along with the image data.

Referring back to FIG. 2, the processing server 110 can also include a memory 218. The memory 218 can be configured to store data for use by the processing server 110 in performing the functions discussed herein such as the data stored in the database 206. The memory 218 can be configured to store data using suitable data formatting methods and schema and can be any suitable type of memory, such as read-only memory, random access memory, etc. The memory 218 can include, for example, encryption keys and algorithms, communication protocols and standards, data formatting standards and protocols, program code for modules and application programs of the processing device, and other data that can be suitable for use by the processing server 110 in the performance of the functions disclosed herein as will be apparent to persons having skill in the relevant art. In some embodiments, the memory 218 can be comprised of or can otherwise include a relational database, e.g., the database 206, that utilizes structured query language for the storage, identification, modifying, updating, accessing, etc. of structured data sets stored therein.

The processing server 110 can include a querying module 220. The querying module 220 can be configured to execute queries on databases to identify information. The querying module 220 can receive one or more data values or query strings and can execute a query string based thereon on an indicated database, such as the database 206 of the processing server 110 to identify information stored therein. The querying module 220 can then output the identified information to an appropriate engine or module of the processing server 110 as necessary. The querying module 220 can, for example, execute a query on the database 206 to identify a property profile 208 that corresponds to the property 102 identified in a user request.

The processing server 110 can include an analysis module 222. The analysis module 222 can be configured to analyze data for use by the processing server 110 in performing the functions discussed herein. The analysis module 222 can utilize the one or more property algorithms 216 to analyze the image property data 210, e.g., the video feed of the property 102 captured by the imaging device 106 and output the results to the generation module 224. The analysis module 222 can receive user instructions from the user computing device 112A-C as input and process the user instructions for use by the processing server 110. For example, the analysis module 222 can receive a voice command from the user computing device 112A and input the voice command into a large language model to parse and translate the voice command for use by the processing server 110. The analysis module 222 can receive the user data 214 as input and analyze the user data 214 to determine a percentage or portion of the property 102 that was viewed by the associated user and output the determination for use by the processing server 110. For example, the analysis module 222 can determine from the user data 214 that a user, e.g., of the user computing device 112A, viewed three of ten waypoints of a piece of property and output that determination, e.g., property viewing metrics, to the generation module 224 for generation of a property report.

The processing server 110 can also include a generation module 224. The generation module 224 can be configured to generate data for use by the processing server 110 in performing the functions discussed herein. The generation module 224 can receive instructions as input, can generate data based on the instructions, and can output the generated data to one or more modules of the processing server 110. The generation module 224 can be configured to generate floor plans, e.g., floor plan 300, for the property 102, the property profiles 208, the user profiles 212, the property algorithms 216, the data objects 217, instructions for transmission to the devices of the system 100, e.g., the ground unit computing device 104, the imaging device 106, and/or the user computing devices 112A-C, virtual reality video feeds, augmented virtual reality video feeds, property reports, etc. For example, the generation module 224 can receive property viewing metrics from the analysis module 222 as input and generate a property report indicating the percentage of the property that was viewed by one or more users, e.g., the user computing devices 112A-C. The property report can include a total number of users, e.g., user computing devices 112A-C, that started a tour of the property 102, a total number of users, e.g., user computing devices 112A-C, that completed a tour of the property 102, a percentage of the users who started a tour of the property 102 who completed a full tour of the property 102, an average percentage of the property 102 that was viewed by all users who started a tour of the property 102, user viewing percentages of each room of the property 102, an amount of time spent viewing the property 102 by each of the users who started a tour of the property 102, an average time spent viewing the property 102 by all of the users who started a tour of the property 102, a number of times each user viewed the property 102, user reactions to the property 102, etc. The generation module 224 can also receive user inputs from the analysis module 222, e.g., translated voice commands, or user inputs directly from the user computing device 112A-C, and generate responses to those user inputs for output to the user computing devices 112A-C. For example, a user, e.g., on the user computing device, may generate an input requesting the imaging device to show them the basement of the property 102. The analysis module 222 may determine that there is no basement for the property 102, e.g., based on the floor plan of the property 102, and the generation module 224 may generate a response to the user. For example, the generation module 224 may generate a response to the user indicating that there is no basement for the property 102. The generation module 224 may also generate a response suggesting a next room the user may like to see that is available in the property 102.

The processing server 110 can also include a transmitting device 226. The transmitting device 226 can be configured to transmit data over one or more networks, e.g., the network 108, via one or more network protocols. In some instances, the transmitting device 226 can be configured to transmit data to the ground unit computing device 104, the imaging device 106, the user computing devices 112A-C, and other entities via one or more communication methods, local area networks, wireless area networks, cellular communication, Bluetooth, radio frequency, the Internet, etc. In some embodiments, the transmitting device 226 can be comprised of multiple devices, such as different transmitting devices for transmitting data over different networks, such as a first transmitting device for transmitting data over a local area network and a second transmitting device for transmitting data via the Internet. The transmitting device 226 can electronically transmit data signals that have data superimposed that can be parsed by a receiving computing device. In some instances, the transmitting device 226 can include one or more modules for superimposing, encoding, or otherwise formatting data into data signals suitable for transmission.

The transmitting device 226 can be configured to electronically transmit data signals to the user devices 112A-C, which can be superimposed or otherwise encoded with property viewing requests, property tour inputs, property measurement requests, virtual object requests, virtual object specification inputs, imaging device requests, etc. The transmitting device 226 can also be configured to transmit data signals electronically transmitted by the ground unit computing device 104 and/or the imaging device 106 that can be superimposed or otherwise encoded with images of property, video of property, live video of property, augmented reality video of property, virtual reality video of property, property metrics, property measurements, property floor plans, sensor data, etc.

### Process for Remote Viewing of Property

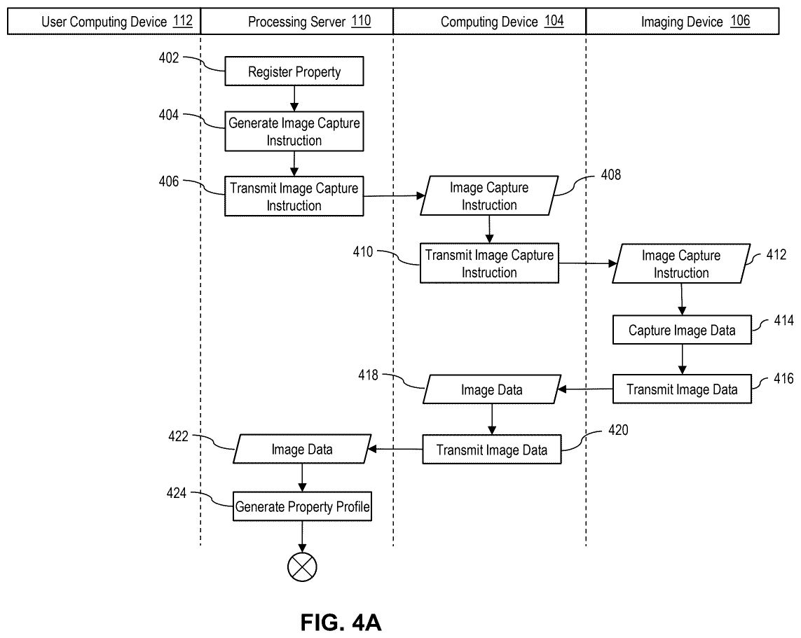

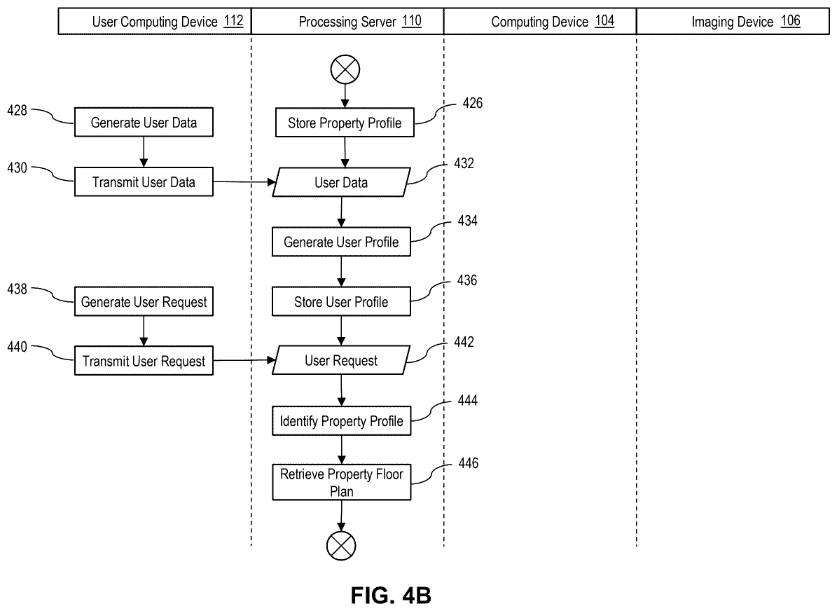

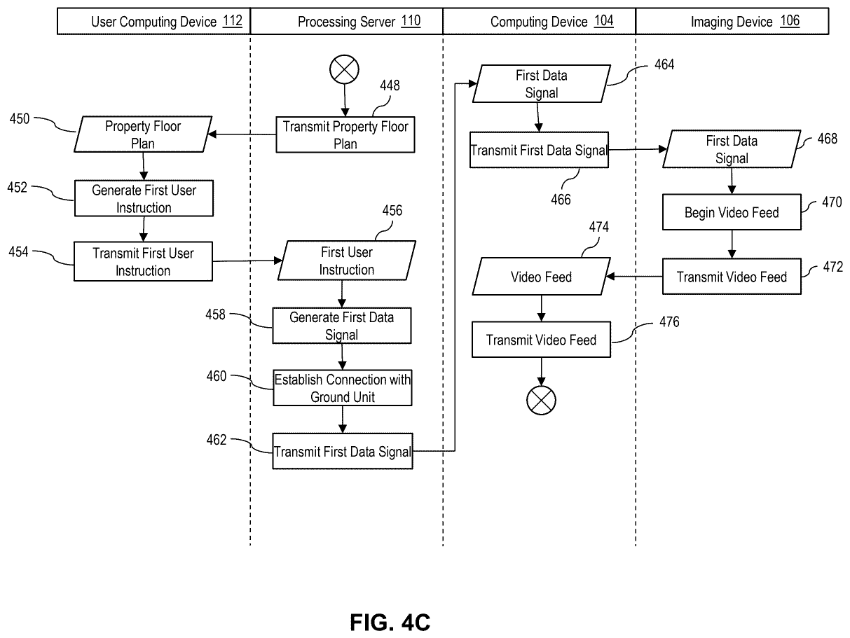

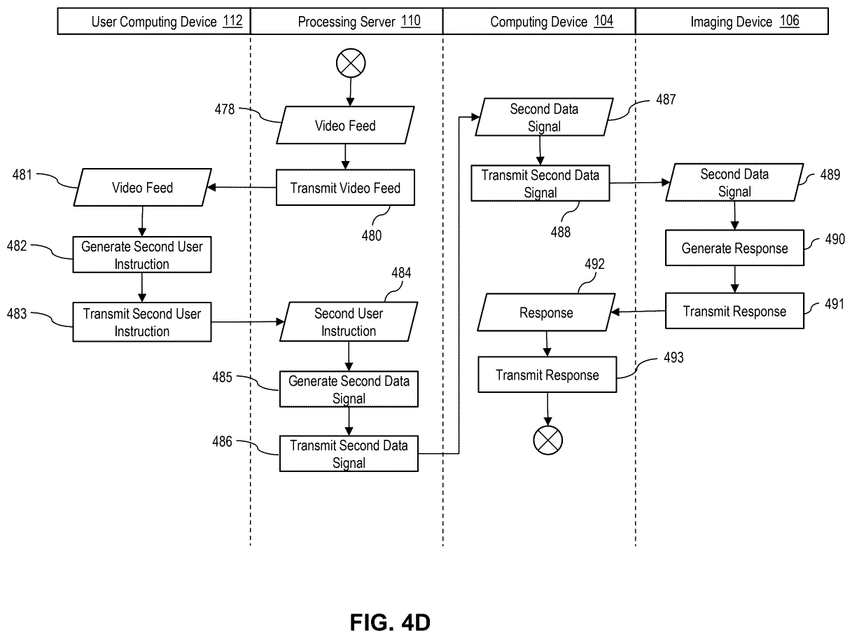

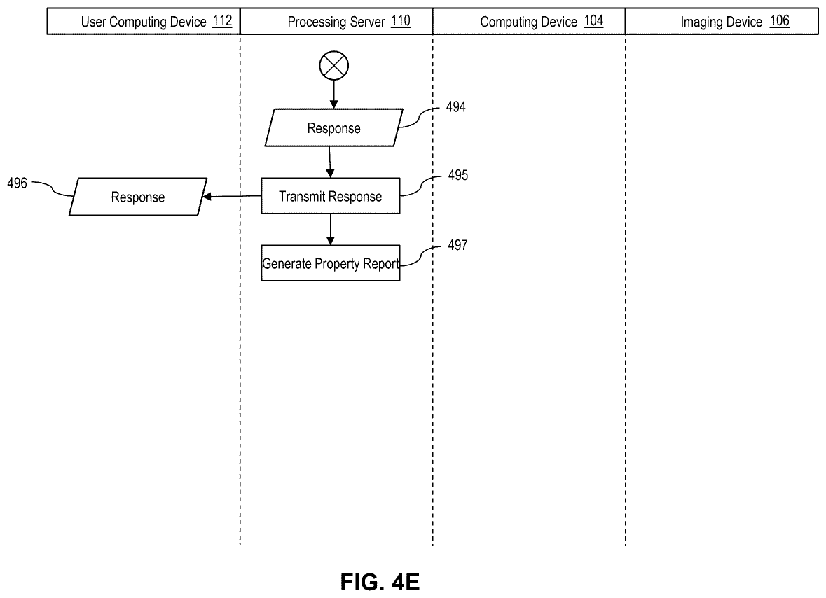

FIGS. 4A-4E illustrate a process 400 in the system 100 of FIG. 1 for remote viewing of property.

In step 402, an entity in the system 100 can register a piece of property, e.g., the property 102, with the system 100 via the user devices 112A-C and/or the processing server 110. The entity can be a real estate agent, a property owner, a property lender, etc. who is adding the property 102 to the system. In embodiments, the ground unit computing device 104 and/or the imaging device 106 are deployed in or near the property 102. Registering the property 102 can include receiving property data, e.g., the property data 210, from the user computing devices 112A-C. Registering the property 102 with the system 100 cause the processing server 110 to generate an image capture instruction in step 404. The image capture instruction can be a data signal superimposed with an instruction to cause the imaging device 106 to capture video of the property 102. The processing server 110 transmits the image capture instruction to the ground unit computing device 104, which can be configured as a base station for the imaging device 106, in step 406. In embodiments, the image capture instruction may be generated by the ground unit computing device 104.

In step 408, the ground unit computing device 104 receives the image capture instruction and transmits the image capture instruction to the imaging device 106 in step 410. In embodiments, the ground unit computing device 104 and the imaging device 106 can be a single device and in such embodiments the processing server 110 may transmit the image capture instruction directly to the imaging device 106.

In step 412, the imaging device 106 receives the image capture instruction and proceeds to capture image data of the property 102 in step 414. In exemplary embodiments, the image data is video data of the property 102. In step 416, the imaging device 106 transmits the captured image data to the ground unit computing device 104. The imaging device 106 may continuously transmit the image data to the ground unit computing device 104 as the imaging device 106 captures the image data, or the imaging device 106 may capture all the image data of the property 102 before transmitting the image data to the ground unit computing device 104.

In step 418, the ground unit computing device 104 receives the image data of the property 102 from the imaging device 106 and transmits the image data to the processing server 110 in step 420. As discussed above, in embodiments, the ground unit computing device 104 and the imaging device 106 can be a single device and in such embodiments the imaging device 106 may transmit the captured image data directly to the processing server 110.

In step 422, the processing server 110 receives the image data from the ground unit computing device. In step 424, the processing server 110 generates a property profile, e.g., the property profile 208, based on the captured image data and the property data, e.g., the property data 210, received during registration of the property 102. It can be appreciated that the processing server 110 can generate the property profile, e.g., the property profile 208, at the time of registration and in step 422, the processing server 110 can add the captured image data to the property profile, e.g., the property profile 208. In step 426, the processing server 110 can store the property profile, e.g., the property profile 208, in a database, e.g., the database 206.

In step 428, a user, e.g., via the user computing device 112A, generates user data, e.g., user data 214, and transmits the user data, e.g., the user data 214, to the processing server 110 in step 430.

In step 430, the processing server 110 receives the user data, e.g., the user data 214, from the user, e.g., via the user computing device 112A. In step 432, the processing server 110 generates a user profile, e.g., the user profile 212, for the user, e.g., the user of the user computing device 112A. Once the user profile, e.g., the user profile 212, has been created, the processing server 110 may notify the user of successful creation of the user profile. For example, the processing server 110 can generate a notification for display on the user computing device 112A, e.g., via a user interface. Instep 436, the processing server 110 stores the user profile, e.g., the user profile 212, in a database, e.g., the database 206.

In step 438, the user, e.g., via the user computing device 112A, generates a user request to view a property, e.g., the property 102. The user request can include at least a property identifier, e.g., of the property 102. In embodiments, the user request may include a user height. In step 440, the user, e.g., via the user computing device 112A, transmits the user request to the processing server 110. The user may enter the user request via a user interface such as a GUI, an API, a webpage, etc., on the user computing device 112A.

In step 442, the processing server 110 receives the user request from the user, e.g. via the user computing device 112A. In step 444, the processing server 110 identifies a property profile, e.g., the property profile 208, that includes the property identifier in the user request. In step 446, the processing server 110 a computing retrieves, from the database 206, a property floor plan included in the identified property profile, e.g., the property profile 208. In step 448, the processing server 110 transmits the property floor plan included in the identified property profile, e.g., the property profile 208, to the user computing device 112A. The processing server 110 may transmit the property floor plan included in the identified property profile, e.g., the property profile 208, as any suitable data file.

In step 450, the user, e.g., via the user computing device 112A, receives the property floor plan included in the identified property profile, e.g., the property profile 208. In step 452, the user, e.g., via the user computing device 112A, generates a first user instruction to view one or more locations within the property 102. The one or more locations within the property 102 may be one or more waypoints 302 included in the floor plan of the property 102. The one or more locations may also be a pre-set video path of the property 102. In step 454, the user, e.g., via the user computing device 112A, transmits the first user instruction to the processing server 110.

In step 456, the processing server 110 receives the first user instruction and proceeds to generate a first data signal instructing the ground unit computing device 104 to cause the imaging device 106 to move to the one or more locations within the property 102 included in the first user instruction in step 458. The first data signal may include the user height and an instruction to cause the imaging device 106 to adjust to the user height. For example, the imaging device 106 may be a drone and the drone may adjust its vertical position such that the imaging device is level with the user's height; thus, allowing the image data captured by the imaging device 106 to appear from a similar vantage point as if the user were physically present themselves. In embodiments, the first user instruction can be a voice command and in generating the first data signal, the processing server 110 can parse the voice command and translate the voice command into a text command for inclusion in the first data signal.

In step 460, the processing server 110 establishes a connection with the ground unit computing device 104 and transmits the first data signal to the ground unit computing device 104 in step 462. In embodiments, the user computing device 112A, can transmit the first user instruction directly to the ground unit computing device 104 and the ground unit computing device 104 can generate the first data signal.

In step 464, the ground unit computing device 104 receives the first data signal from the processing server 110 and transmits the first data signal to the imaging device 106 in step 466. As discussed above, in embodiments, the ground unit computing device 104 and the imaging device 106 can be a single device and in such embodiments the processing server 110 may transmit the first data signal directly to the imaging device 106.

In step 468, the imaging device 106 receives the first data signal from the ground unit computing device 104 and the imaging device 106 begins to capture a live video feed of the property 102 from the one or more locations specified in the first user instruction in step 470. In step 472, the imaging device 106 transmits the live video feed of the property 102 to the ground unit computing device 104.

In step 474, the ground unit computing device 104 receives the live video feed of the property 102 from the imaging device 106 and transmits the live video feed of the property 102 to the processing server 110 in step 476. As discussed above, in embodiments, the ground unit computing device 104 and the imaging device 106 can be a single device and in such embodiments the imaging device 106 may transmit the live video feed of the property 102 directly to the processing server 110.

In step 478, the processing server 110 receives the live video feed from the ground unit computing device 104 and transmits the live video feed of the property 102 to the user, e.g., to the user computing device 112A in step 480. In embodiments, the ground unit computing device 104 can transmit the live video feed directly to the user, e.g., to the user computing device 112A.

In step 481, the user, e.g., via the computing device 112A, receives the live video feed of the property 102 from the processing server 110. In embodiments, once a user has viewed the one or more locations, e.g., one or more waypoints 302, the processing server 110 may generate a notification indicating the user has completed that particular waypoint 302. For example, the processing server 110 may turn the waypoint 302 and/or the room associated with the waypoint 302 on the floor plan of the property 102 a different color, e.g., green, to indicate to the user they have viewed that particular waypoint 302 and/or the room. In another example, the processing server 110 may generate a pop-up notification for display to the user on the user computing device 112A indicating the user has viewed that particular waypoint 302 and/or the room.

In step 482, the user, e.g., via the computing device 112A, generates a second user instruction to measure a first distance at the one or more locations within the property 102. In step 483, the user, e.g., via the computing device 112A, transmits the second user instruction to the processing server 110.

In step 484, the processing server 110 received the second user instruction from the user computing device 112. In step 485, the processing server 110 generates a second data signal instructing the ground unit computing device 104 to cause the imaging device 106 to measure the first distance at the one or more locations within the property 102. The first distance may be one or more of: a wall height, a wall width, a floor length, a floor width, a ceiling height, a doorway height, a doorway width, a window height, a window width, a window distance from a floor, an object width, an object depth, and an object length, etc. In embodiments, the second data signal can instruct the imaging device 106 to capture a still image of the one or more locations where the user would like a distance measured. The imaging device 106 can transmit the captured still image to the ground unit computing device 104 and/or the processing server 110, which can then generate the first distance of the one or more locations. In step 486, the processing server 110 transmits the second data signal to the ground unit computing device 104. In embodiments, the user computing device 112A, can transmit the second user instruction directly to the ground unit computing device 104 and the ground unit computing device 104 can generate the second data signal.

In step 487, the ground unit computing device 104 receives the second data signal from the processing server 110 and transmits the second data signal to the imaging device 106 in step 488.

In step 489, the imaging device 106 receives the second data signal from the ground unit computing device 104. As discussed above, in embodiments, the ground unit computing device 104 and the imaging device 106 can be a single device and in such embodiments the processing server 110 may transmit the second data signal directly to the imaging device 106.

In step 490, the imaging device 106 generates a response to the second data signal. For example, the imaging device 106 may measure the first distance using one of the one or more sensors on the imaging device 106 or the imaging device 106 may capture a still image of the one or more locations. In step 491, the imaging device 106 transmits the response to the ground unit computing device 104.

In step 492, the ground unit computing device 104 receives the response to the second data signal from the imaging device 106 and transmits the response to the processing server 110 in step 493. As discussed above, in embodiments, the ground unit computing device 104 and the imaging device 106 can be a single device and in such embodiments the imaging device 106 may transmit the response to the second data signal directly to the processing server 110.

In step 494, the processing server 110 receives the response to the second data signal from the ground unit computing device 104 and transmits the response to the second data signal to the user computing device 112A in step 495. In step 496, the user, e.g., via the user computing device 112A, receives the response to the second data signal from the processing server 110. In embodiments, the ground unit computing device 104 can transmit the response to the second data signal directly to the user, e.g., to the user computing device 112A.

In step 497, the processing server 110 generates a property report that includes the user interactions, e.g., the interactions of the user computing device 112A, with the property 102 as discussed in more detail above with reference to FIG. 2.

In the process 400, the processing server 110, the ground unit computing device 104, and the imaging device 106 can all be a single computing device or each of the processing server 110, the ground unit computing device 104, and the imaging device 106 can be combined with one another in any suitable configuration as discussed in more detail above with reference to FIG. 1.

### Exemplary Method for Remote Viewing of Property

FIG. 5 illustrates a method 500 for remote viewing of property in the system 100 of FIG. 1.

In step 502, a computing device (e.g., the processing server 110) may store, in a database (e.g., the database 206), one or more property profiles (e.g., property profiles 208). Each of the property profiles (e.g., property profiles 208) may correspond to a property (e.g., the property 102) and each of the one or more property profiles (e.g., property profiles 208) may include property data 210 such as a property identifier, a property floor plan, and a ground unit computing device identifier. The property (e.g., the property 102) that corresponds to each property profile (e.g., property profile 208) may be any transferable property including real property and/or personal property.

In step 504, a computing device (e.g., the processing server 110) may receive, from a user computing device (e.g., the user computing device 112A), a user request to view a property (e.g., the property 102) that corresponds to one of the one or more property profiles (e.g., property profiles 208). The user request may include at least a property identifier. Further, the user request may include a user height.

In step 506, a computing device (e.g., the processing server 110) may identify a property profile of the one or more property profiles (e.g., property profiles 208) that includes the property identifier included in the user request.

In step 508, a computing device (e.g., the processing server 110) may retrieve, from the database (e.g., the database 206), a property floor plan included in the identified property profile. The floor plan included in the identified property profile may be generated (e.g., by the ground unit computing device 104, the imaging device 106, and/or the processing server 110) based on one or more scans of the property (e.g., the property 102) by an imaging device (e.g., the imaging device 106). In order to generate the floor plan, a computing device (e.g., the processing server 110) may receive, from the imaging device (e.g., the imaging device 106), via a ground unit computing device (e.g., the ground unit computing device 104), the one or more scans of the property (e.g., the property 102). The floor plan may be generated based on the one or more scans of the property using an image classification algorithm.

In step 510, a computing device (e.g., the processing server 110) may display the property floor plan on the user computing device (e.g., the user computing device 112A) via a graphical user interface (GUI).

In step 512, a computing device (e.g., the processing server 110) may establish a connection to a ground unit computing device (e.g., the ground unit computing device 104) associated with the ground unit computing device identifier included in the identified property profile (e.g., the property profile 208). The ground unit computing device (e.g., the ground unit computing device 104) may be communicatively coupled to an imaging device (e.g., the imaging device 106). In embodiments, the ground unit computing device (e.g., the ground unit computing device 104) may be a base station computing device located at the property (e.g., the property 102) and the imaging device (e.g., the imaging device 106) may be a drone that has a 360-degree camera. The imaging device (e.g., the imaging device 106) may have one or more sensors including one or more of: a Lidar, an Infrared sensor, an ultrasonic sensor, wheel encoders, a stereo camera, an embedded computer, an inertial Measurement unit, a stereo Camera, and an infrared Laser Dot Projector, etc.

In step 514, a computing device (e.g., the processing server 110) may receive a first user instruction, via the GUI, to view one or more locations within the property (e.g., the property 102). The first user instruction may be a voice command.

In step 516, a computing device (e.g., the processing server 110) may generate a first data signal instructing the ground unit computing device (e.g., the ground unit computing device 104) to cause the imaging device (e.g., the imaging device 106) to move to the one or more locations within the property (e.g., the property 102) included in the first user instruction. The first data signal may include the user height and an instruction to cause the imaging device (e.g., the imaging device 106) to adjust to the user height. When the first user instruction is a voice command, generating the first data signal may include parsing (e.g., by the processing server 110) the voice command and translating the voice command into a text command.

In step 518, a computing device (e.g., the processing server 110) may transmit the first data signal to the ground unit computing device (e.g., the ground unit computing device 104).

In step 520, a computing device (e.g., the processing server 110) may receive, from the ground unit computing device (e.g., the ground unit computing device 104), a live video feed from the imaging device (e.g., the imaging device 106) of the one or more locations. The live video feed from the imaging device (e.g., the imaging device 106) may be from the user height.

In embodiments, the live video feed may be an augmented virtual reality video feed and a computing device (e.g., the processing server 110) may receive, from the user computing device (e.g., the user computing device 112A) via the GUI, a second user instruction to measure a first distance at the one or more locations within the property (e.g., the property 102). In response to receiving the second user instruction, a computing device (e.g., the processing server 110) may generate a second data signal instructing the ground unit computing device (e.g., the ground unit computing device 104) to cause the imaging device (e.g., the imaging device 106) to measure the first distance at the one or more locations within the property (e.g., the property 102). The first distance may be one or more of: a wall height, a wall width, a floor length, a floor width, a ceiling height, a doorway height, a doorway width, a window height, a window width, a window distance from a floor, an object width, an object depth, and an object length, etc.

In embodiments, a computing device (e.g., the processing server 110) may store, in the database (e.g., the database 206), one or more virtual data objects (e.g., data objects 217), that can be placed within the augmented virtual reality live video feed of the property (e.g., the property 102). The one or more virtual data objects (e.g., data objects 217) may have adjustable dimensions. A computing device (e.g., the processing server 110) may receive a third user instruction to insert a virtual object of the one or more virtual data objects (e.g., data objects 217) in a specific location within the property (e.g., the property 102). The third user instruction may define a length, a width, and a height for the virtual object of the one or more virtual data objects (e.g., data objects 217). A computing device (e.g., the processing server 110) may generate the virtual object having the defined length, width, and height and a computing device (e.g., the processing server 110) may insert the generated virtual object at the specific location within the property (e.g., the property 102) in the augmented virtual reality video feed.

In embodiments, a computing device (e.g., the processing server 110) may monitor, via the GUI, user interaction with the property (e.g., the property 102). A computing device (e.g., the processing server 110) may store, in a property profile (e.g., the property profile 208) corresponding to the property (e.g., the property 102), the user interactions with the property (e.g., the property 102). A computing device (e.g., the processing server 110) may generate a report based on the user interactions with the property (e.g., the property 102). The report may include a percentage of the floor plan viewed by the user.

### Computer System Architecture

FIG. 6 illustrates a computer system 600 in which embodiments of the present disclosure, or portions thereof, can be implemented as computer-readable code. For example, the ground unit computing device 104, the imaging device 106, the processing server 110, and/or the user computing devices 112A-C can be implemented in the computer system 600 using hardware, non-transitory computer readable media having instructions stored thereon, or a combination thereof and can be implemented in one or more computer systems or other processing systems. Hardware can embody modules and components used to implement the methods of FIGS. 4A-4E, and 5.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 604 can be a special purpose or a general-purpose processor device specifically configured to perform the functions discussed herein. The processor device 604 can be connected to a communications infrastructure 606, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 can also include a main memory 608 (e.g., random access memory, read-only memory, etc.), and can also include a secondary memory 610. The secondary memory 610 can include the hard disk drive 612 and a removable storage drive 614, such as a floppy disk drive, a magnetic tape drive, an optical disk drive, a flash memory, etc.

The removable storage drive 614 can read from and/or write to the removable storage unit 618 in a well-known manner. The removable storage unit 618 can include a removable storage media that can be read by and written to by the removable storage drive 614. For example, if the removable storage drive 614 is a floppy disk drive or universal serial bus port, the removable storage unit 618 can be a floppy disk or portable flash drive, respectively. In one embodiment, the removable storage unit 618 can be non-transitory computer readable recording media.

In some embodiments, the secondary memory 610 can include alternative means for allowing computer programs or other instructions to be loaded into the computer system 600, for example, the removable storage unit 622 and an interface 620. Examples of such means can include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art.

The computer system 600 can also include a communications interface 624. The communications interface 624 can be configured to allow software and data to be transferred between the computer system 600 and external devices. Exemplary communications interfaces 624 can include a modem, a network interface (e.g., an Ethernet card), a communications port, a PCMCIA slot and card, etc. Software and data transferred via the communications interface 624 can be in the form of signals, which can be electronic, electromagnetic, optical, or other signals as will be apparent to persons having skill in the relevant art. The signals can travel via a communications path 626, which can be configured to carry the signals and can be implemented using wire, cable, fiber optics, a phone line, a cellular phone link, a radio frequency link, etc.

The computer system 600 can further include a display interface 602. The display interface 602 can be configured to allow data to be transferred between the computer system 600 and external display 630. Exemplary display interfaces 602 can include high-definition multimedia interface (HDMI), digital visual interface (DVI), video graphics array (VGA), etc. The display 630 can be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 608 and secondary memory 610, which can be memory semiconductors (e.g., DRAMs, etc.). These computer program products can be a means for providing software to the computer system 600. Computer programs (e.g., computer control logic) can be stored in the main memory 608 and/or the secondary memory 610. Computer programs can also be received via the communications interface 624. Such computer programs, when executed, can enable computer system 600 to implement the present methods as discussed herein. In particular, the computer programs, when executed, can enable processor device 604 to implement the methods illustrated by FIGS. 4A-4E, and 5, as discussed herein. Accordingly, such computer programs can represent controllers of the computer system 600. Where the present disclosure is implemented using software, the software can be stored in a computer program product and loaded into the computer system 600 using the removable storage drive 614, interface 620, and hard disk drive 612, or communications interface 624.

The processor device 604 can comprise one or more modules or engines configured to perform the functions of the computer system 600. Each of the modules or engines can be implemented using hardware and, in some instances, can also utilize software, such as corresponding to program code and/or programs stored in the main memory 608 or secondary memory 610. In such instances, program code can be compiled by the processor device 604 (e.g., by a compiling module or engine) prior to execution by the hardware of the computer system 600. For example, the program code can be source code written in a programming language that is translated into a lower-level language, such as assembly language or machine code, for execution by the processor device 604 and/or any additional hardware components of the computer system 600. The process of compiling can include the use of lexical analysis, preprocessing, parsing, semantic analysis, syntax-directed translation, code generation, code optimization, and any other techniques that can be suitable for translation of program code into a lower-level language suitable for controlling the computer system 600 to perform the functions disclosed herein. It will be apparent to persons having skill in the relevant art that such processes result in the computer system 600 being a specially configured computer system 600 uniquely programmed to perform the functions discussed above.

Techniques consistent with the present disclosure provide, among other features, systems and methods for facilitating direct metaverse payments via metaverse currency without direct currency conversion. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

1. A method for remote viewing of property, comprising:
storing, in a database, one or more property profiles, each of the one or more property profiles corresponding to a property, and each of the one or more property profiles including at least a property identifier, a property floor plan, and a ground unit computing device identifier;
receiving, from a user computing device, a user request to view a property corresponding to one of the one or more property profiles, the user request including at least a property identifier;
identifying a property profile of the one or more property profiles including the property identifier included in the user request;
retrieving, from the database, a property floor plan included in the identified property profile;
displaying the property floor plan on the user computing device via graphical user interface (GUI);
establishing a connection to a ground unit computing device associated with the ground unit computing device identifier included in the identified property profile, wherein ground unit computing device is communicatively coupled to an imaging device;
receiving a first user instruction, via the GUI, to view one or more locations within the property;
generating a first data signal instructing the ground unit computing device to cause the imaging device move to the one or more locations within the property included in the first user instruction;
transmitting the first data signal to the ground unit computing device; and
receiving, from the ground unit computing device, a live video feed from the imaging device of the one or more locations included in the first user instruction.

2. The method of claim 1, wherein the user request includes a user height;
wherein the first data signal includes the user height and an instruction to cause the imaging device to adjust to the user height; and
wherein the live video feed from the imaging device is from the user height.

3. The method of claim 1, wherein the first user instruction is a voice command; and
wherein the generating the first data signal includes:
parsing the voice command, and
translating the voice command into a text command.

4. The method of claim 1, further comprising:
receiving, from the user computing device via the GUI, a second user instruction to measure a first distance at the one or more locations within the property;
generating a second data signal instructing the ground unit computing device to cause the imaging device to measure the first distance at the one or more locations within the property;
transmitting the second data signal to the ground unit computing device; and receiving from the ground unit computing device a measurement of the first distance at the one or more locations within the property.

5. The method of claim 4, wherein the first distance is one or more of: a wall height, a wall width, a floor length, a floor width, a ceiling height, a doorway height, a doorway width, a window height, a window width, a window distance from a floor, an object width, an object depth, and an object length.

6. The method of claim 1, wherein the live video feed is an augmented virtual reality video feed, the method including:
storing in the database one or more virtual data objects that can be placed within the augmented virtual reality live video feed of the property, the one or more virtual data objects having adjustable dimensions;
receiving a third user instruction to insert a virtual object of the one or more virtual data objects in a specific location within the property, the third user instruction defining a length, a width, and a height for the virtual object of the one or more virtual data objects;
generating the virtual object having the defined length, width, and height; and
inserting the generated virtual object at the specific location within the property in the augmented virtual reality video feed.

7. The method of claim 1, further comprising:
monitoring, via the GUI, user interaction with the property;
storing, in property profile corresponding to the property, the user interactions with the property; and
generating a report based on the user interactions with the property, wherein the report includes a percentage of the floor plan viewed by the user.

8. The method of claim 1, wherein the ground unit computing device is a base station computing device.

9. The method of claim 1, wherein the imaging device is a drone including a 360-degree camera.

10. The method of claim 1, wherein the property is a piece of real property.

11. The method of claim 1, wherein the imaging device has one or more sensors including one or more of: a Lidar, an Infrared sensor, an ultrasonic sensor, wheel encoders, a stereo camera, an embedded computer, an inertial Measurement unit, a stereo Camera, and an infrared Laser Dot Projector.

12. The method of claim 1, wherein the floor plan in generated based on one or more scans of the property by the imaging device, the method including:
receiving, from the imaging device via the ground unit computing device, the one or more scans of the property; and
generating the floor plan based on the one or more scans of the property using an image classification algorithm.

13. A system for remote viewing of property, comprising:
a user computing device;
a ground unit computing device;
an imaging device, and
a processing server, the processing server configured to perform a method of:
storing, in a database, one or more property profiles, each of the one or more property profiles corresponding to a property, and each of the one or more property profiles including at least a property identifier, a property floor plan, and a ground unit computing device identifier;
receiving, from a user computing device, a user request to view a property corresponding to one of the one or more property profiles, the user request including at least a property identifier;
identifying a property profile of the one or more property profiles including the property identifier included in the user request;
retrieving, from the database, a property floor plan included in the identified property profile;
displaying the property floor plan on the user computing device via graphical user interface (GUI);
establishing a connection to a ground unit computing device associated with the ground unit computing device identifier included in the identified property profile, wherein ground unit computing device is communicatively coupled to an imaging device;
receiving a first user instruction, via the GUI, to view one or more locations within the property;
generating a first data signal instructing the ground unit computing device to cause the imaging device move to the one or more locations within the property included in the first user instruction;
transmitting the first data signal to the ground unit computing device; and
receiving, from the ground unit computing device, a live video feed from the imaging device of the one or more locations included in the first user instruction.

14. The system of claim 13, wherein the user request includes a user height;
wherein the first data signal includes the user height and an instruction to cause the imaging device to adjust to the user height; and
wherein the live video feed from the imaging device is from the user height.

15. The system of claim 13, wherein the first user instruction is a voice command; and
wherein the generating the first data signal includes:
parsing the voice command, and
translating the voice command into a text command.

16. The system of claim 13, further comprising:
receiving, from the user computing device via the GUI, a second user instruction to measure a first distance at the one or more locations within the property;
generating a second data signal instructing the ground unit computing device to cause the imaging device to measure the first distance at the one or more locations within the property;
transmitting the second data signal to the ground unit computing device; and receiving from the ground unit computing device a measurement of the first distance at the one or more locations within the property.

17. The system of claim 16, wherein the first distance is one or more of: a wall height, a wall width, a floor length, a floor width, a ceiling height, a doorway height, a doorway width, a window height, a window width, a window distance from a floor, an object width, an object depth, and an object length.

18. The system of claim 13, wherein the live video feed is an augmented virtual reality video feed, the method including:
storing in the database one or more virtual data objects that can be placed within the augmented virtual reality live video feed of the property, the one or more virtual data objects having adjustable dimensions;
receiving a third user instruction to insert a virtual object of the one or more virtual data objects in a specific location within the property, the third user instruction defining a length, a width, and a height for the virtual object of the one or more virtual data objects;
generating the virtual object having the defined length, width, and height; and
inserting the generated virtual object at the specific location within the property in the augmented virtual reality video feed.

19. The system of claim 13, further comprising:
monitoring, via the GUI, user interaction with the property;
storing, in property profile corresponding to the property, the user interactions with the property; and
generating a report based on the user interactions with the property, wherein the report includes a percentage of the floor plan viewed by the user.

20. The system of claim 13, wherein the ground unit computing device is a base station computing device.

21. The system of claim 13, wherein the imaging device is a drone including a 360-degree camera.

22. The system of claim 13, wherein the property is a piece of real property.

23. The system of claim 13, wherein the imaging device has one or more sensors including one or more of: a Lidar, an Infrared sensor, an ultrasonic sensor, wheel encoders, a stereo camera, an embedded computer, an inertial Measurement unit, a stereo Camera, and an infrared Laser Dot Projector.

24. The system of claim 13, wherein the floor plan in generated based on one or more scans of the property by the imaging device, the method including:
receiving, from the imaging device via the ground unit computing device, the one or more scans of the property; and
generating the floor plan based on the one or more scans of the property using an image classification algorithm.
